(19) United States
(12) Patent Application Publication
(10) Pub. No.: US 2023/0418684 A1
(43) Pub. Date: Dec. 28, 2023

(54) ACCELERATOR SERVICE CATALOG AND ORCHESTRATION

(71) Applicant: Dell Products L.P., Round Rock, TX (US)

(72) Inventors: Stephen J. Todd, North Andover, MA (US); Victor Fong, Melrose, MA (US); Benjamin E. Santaus, Somerville, MA (US); Brendan Burns Healy, Whitefish Bay, WI (US)

(21) Appl. No.: 17/809,079

(22) Filed: Jun. 27, 2022

(51) Int. Cl. G06F 9/50; G06F 9/54

(52) U.S. Cl. CPC G06F 9/5083; G06F 9/543

(57) ABSTRACT

One example method includes identifying an accelerator service instance associated with a workload, calling a service broker associated with the accelerator service instance to obtain information needed to use the accelerator service instance, receiving an accelerator call, and accelerator job information concerning an accelerator job, from the workload, in response to the accelerator call, spinning up a new process dedicated to the accelerator job, as part of the new process, running the accelerator job using either the accelerator service instance, or a locally available accelerator, and returning data, generated by running the accelerator job, to the workload.

### FIELD OF THE INVENTION

Embodiments of the present invention generally relate to quantum computing systems. More particularly, at least some embodiments of the invention relate to systems, hardware, software, computer-readable media, and methods for the implementation and use of a quantum accelerator service catalog and broker.

### BACKGROUND

In the quantum computing arena, and others, hardware known as ‘accelerators’ are used to improve performance in the execution of workloads. The accelerators may provide a high level of performance, such as in terms of workload execution speed, relative to more conventional systems and devices. There are many QPU (quantum processing unit), GPU (graphics processing unit), and other accelerator service providers available, offering similar capabilities.

The type and number of accelerators needed to support the execution of a workload may vary from one workload to another. As a result, a developer may have to switch between accelerator services from time to time in order to support the changing needs. However, switching between accelerator services may be problematic.

For example, when a developer needs to swap between services, the developer typically must manually configure service endpoints and credentials, and may also have to configure security policies and service mesh configuration. Another concern is that developers have no unified way of orchestrating accelerator workloads across local hardware and remote services. Finally, developers are unable to dynamically scale the number of accelerators that a workload has available to it while the workload is running.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture according to some embodiments.

FIG. 2 discloses aspects of an example method according to some embodiments.

FIG. 3 discloses an example computing entity operable to perform any of the claimed methods, processes, and operations.

### DETAILED DESCRIPTION OF SOME EXAMPLE EMBODIMENTS

Embodiments of the present invention generally relate to quantum computing systems. More particularly, at least some embodiments of the invention relate to systems, hardware, software, computer-readable media, and methods for the implementation and use of a quantum accelerator service catalog and broker.

In general, at least some example embodiments of the invention may be directed to the creation and use of a service catalog and broker for various accelerators, examples of which include GPUs and QPUs. Particularly, example embodiments of the invention may enable a developer to select a specific set of accelerators from an available listing and then create and provide credentials for the accelerator services that are provided. The service catalog may also, in some circumstances, provision instances of those services for use by the developer workload via an API provided by the service listing.

This API may connect to an accelerator management process running in the same environment as the developer workload. This environment may be, for example, a CaaS (Container as a Service) environment, or a single server, or any other suitable environment. The accelerator management process may orchestrate the creation of job-specific processes that use an accelerator. These processes may run code that utilizes one kind of accelerator and handle the communication of inputs and outputs between the workload process and an accelerator. The management process may make decisions about which service or locally-attached accelerator to use in each of these processes. In this way the developer workload may be able to dynamically launch multiple accelerator jobs on different kinds of accelerators without directly managing those resources.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an embodiment may reduce, or eliminate, the need for manual configuration of service endpoints and credentials. An embodiment may be able to be implemented into a CaaS environment. An embodiment may provide accelerator service abstraction to avoid any need for a workload to have awareness of the underlying accelerators used by the workload. An embodiment may implement dynamic scaling of accelerators used in the performance of a workload, while the workload is running. Various other advantages of example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of An Example Architecture and Environment

The following is a discussion of aspects of example operating environments for various embodiments of the invention. This discussion is not intended to limit the scope of the invention, or the applicability of the embodiments, in any way.

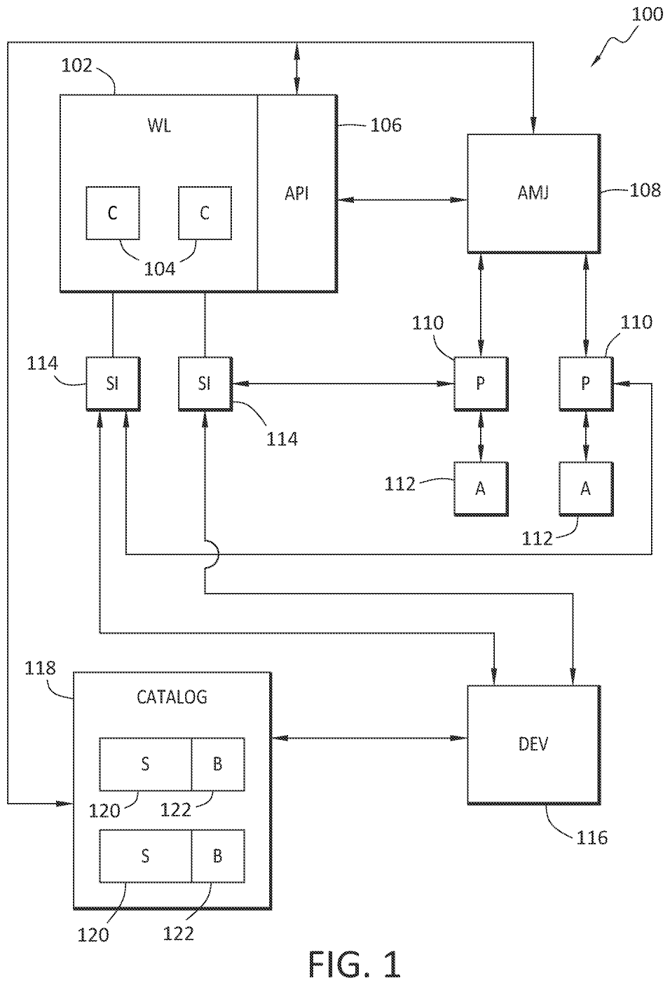

With particular attention now to FIG. 1, one example of an operating environment for embodiments of the invention is denoted generally at 100. In general, the operating environment 100 may include one or more developer workloads 102 that may each comprise one or more containers 104, or other execution environments. The workload 102 may use an API (application program interface) 106 to communicate with an accelerator management job (AMJ) 108 that may be running in the same environment as the workload 102.

The workload 102 may require one or more accelerator jobs to perform the workload. Accordingly, the accelerator management job 108 may spin up one or more processes 110 to perform the accelerator jobs. The processes 110 may use local accelerators 112, or may connect to service instances 114 created by a developer 116 and bound to the workload 102 by the developer 116. In order to create the service instances 114, the developer 116 may browse a service catalog 118 that includes one or more services 120 that are each associated with a respective broker 122.

It is noted that the example architecture 100 in FIG. 1 is provided by way of example and is not intended to limit the scope of the invention in any way. In fact, various modifications and alternative embodiments may be implemented. For example, the launched accelerator processes 100 that use a specific QPU may use a QPU driver to run quantum jobs, instead of using the API 106 to run those quantum jobs.

### B. Operational Aspects of Some Example Embodiments

With continued reference to the example architecture 100 disclosed in FIG. 1, further details are provided now concerning some operational aspects of some example embodiments of the invention. While the following discussion references elements of the example architecture 100, operational aspects may or may not be performed in connection with the example architecture 100.

In general, quantum accelerator services may be offered as plugins to other applications, and developers who wish to add these services may perform small configurations within their application to complete the integration. The listing and provision of available plugins may be implemented by a “service broker,” which may manage the offerings, create credentials for the plugins if necessary, and bind the plugin to the larger application.

Embodiments may employ a host-daemon accelerator management job, such as the accelerator management job 108 for example, running on each machine that has been tagged to run workloads such as the workload 102. The workloads 102 may be run in any suitable environment including, but not limited to, a CaaS environment. The workload 102 machines, and their elements, may have a connection to the service catalog 118. Each accelerator service 120, such as a QPU, GPU, or other accelerator service, may implement a respective service broker 122, which may provide, for example, catalog, create, delete, bind, and unbind, calls.

When a developer 116 writes a workload 102 that requires a specific set of accelerators 112 or accelerator service instances 114, the developer 116 may browse in the service catalog 118 and create the service instances 114 for those accelerators from specific service plans. The developer 116 may then bind the service instances 114 to the workload 102. These accelerator service instances 114 may have the capability to provide multiple accelerator instances to one workload 102.

As the workload container 104 is starting, the accelerator management job 108 may determine that the container 102 has a service instance 114 with accelerator(s) attached and call the service broker 122 to obtain the information needed to utilize the service instance 114, including endpoints, and credentials, for example. When the workload 102 runs, it may utilize the API 106 for its accelerator calls.

Each time the workload 102 requires a new accelerator job, the workload 102 may provide information to the API 106 about the job inputs and outputs. In response, the accelerator management job 108 may then spin up a new process 110 dedicated to that job and connected to an accelerator 112 of the job type. The accelerator management job 108 may determine whether or not the accelerator job process 110 is connected to an available local accelerator 112, or to one provided by a service instance 114. When the accelerator job finishes, its process may return data to the accelerator management job 108, which may then return the data to the workload 102.

### D. Example Methods

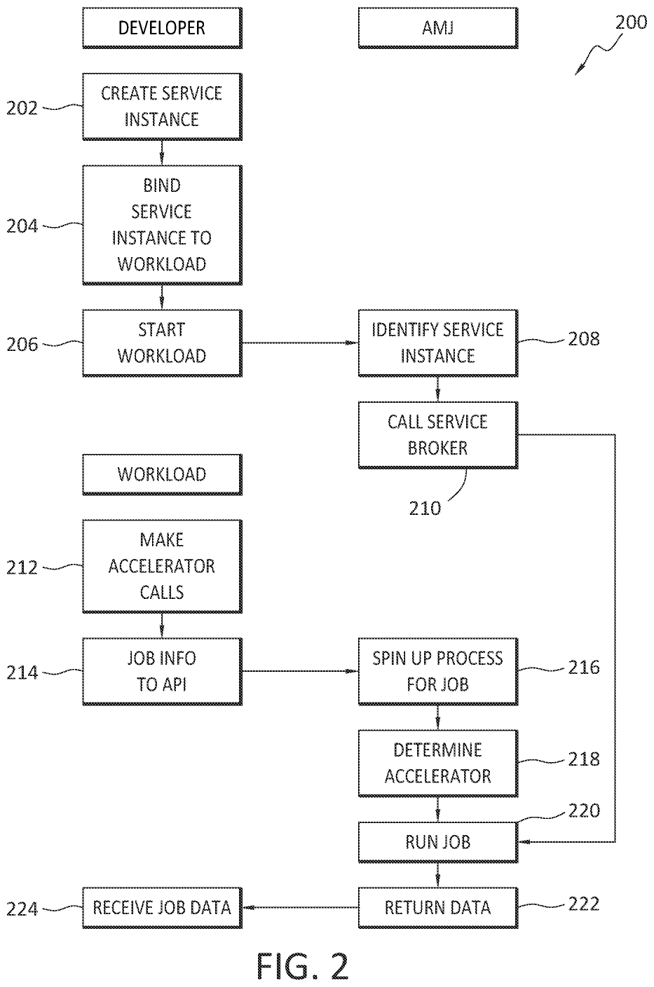

It is noted with respect to the disclosed methods, including the example method of FIG. 2, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 2, an example method 200 according to some embodiments is disclosed. The example method 200 may begin when a developer creates 202 an accelerator service instance, or simply a ‘service instance.’ The developer may then bind 204 the service instance to a workload that is expected to use the accelerator. At this point, the developer may then start 206, or instantiate, the workload.

When the workload is starting 206, the accelerator management job may then determine 208 that a container of the workload is bound to a service instance with one or more accelerators. The accelerator management job may then call 210 the service broker associated with the accelerator and obtain the information needed to run that service instance. When this has been completed, the accelerator may then be available for use by the workload.

As the workload runs, it may make accelerator calls 212, that is, calls to one or more accelerators, administered by the accelerator management job, to perform various aspects of the workload. Particularly, when the workload requires a new accelerator job, the workload may provide job information 214 to the accelerator management job, by way of the API, about various parameters concerning the accelerator job. Such parameters may include, for example, information about the inputs and outputs of the accelerator job.

Based on the accelerator job information, the accelerator management job may then spin up 216 a new process dedicated to the accelerator job. The new process may be connected to an accelerator of the appropriate type for the accelerator job that is to be performed. The accelerator management job may then determine 218 whether the accelerator job is connected to a local accelerator or an accelerator that is being provided by a service instance. After this determination 218 is made, the accelerator management job may run 220 the accelerator job, and return 222 data generated by the accelerator job to the workload, which may then receive 224 the data.

### E. Further Discussion

As will be apparent from this disclosure, example embodiments of the invention may possess various useful features and advantages. For example, an embodiment may provide automated accelerator service listing, creation and binding on service catalog, such as Dell APEX, with an API to have containers gained automated access to QPU or GPU, without any manual configuration. The accelerator service listing may be integrated into a CaaS environment.

An embodiment may provide for service abstraction, so that a workload does not need to be aware of the underlying executing QPU, GPU, or other accelerators. Further, the workload does not need to be aware of even the number of available accelerators, which may change over the course of code execution.

An embodiment may provide dynamic scaling of the number of utilized accelerators at any one time by a single workload. By not reserving more time on remote services than needed, the end user may save on costs, while still getting the maximum benefit of speedup during computationally intensive portions of the workload.

An embodiment may provide an accelerator management process that orchestrates the use of both locally available hardware, such as accelerators, and remote services such as accelerator services. The decision making behind which order to use hardware accelerators in may be configured by the use, but in some cases may default to an “on-prem first” setting. That is, local accelerators may be preferred over accelerator service instances implemented at a remote location. When choosing between multiple remote accelerators of the same type, a user may be able to manually specify constraints and priorities for those remote accelerators. These constraints and priorities may be made job-specific by using code-markers in the workload. If queue time is a constraint, the accelerator management job may utilize an optimization procedure to determine an optimal accelerator selection.

### F. Further Example Embodiments

Following are some further example embodiments of the invention. These are presented only by way of example and are not intended to limit the scope of the invention in any way.
Embodiment 1. A method, comprising: identifying an accelerator service instance associated with a workload; calling a service broker associated with the accelerator service instance to obtain information needed to use the accelerator service instance; receiving an accelerator call, and accelerator job information concerning an accelerator job, from the workload; in response to the accelerator call, spinning up a new process dedicated to the accelerator job; as part of the new process, running the accelerator job using either the accelerator service instance, or a locally available accelerator; and returning data, generated by running the accelerator job, to the workload.
Embodiment 2. The method as recited in embodiment 1, wherein the accelerator service instance is associated with a container of the workload.
Embodiment 3. The method as recited in any of embodiments 1-2, wherein the accelerator service instance is listed in a catalog of selectable accelerator services.
Embodiment 4. The method as recited in any of embodiments 1 and 3, wherein the accelerator call is received from a container of the workload by way of an application program interface.
Embodiment 5. The method as recited in any of embodiments 1-4, wherein the method is performed as part of an accelerator management job.
Embodiment 6. The method as recited in any of embodiments 1-5, wherein a number of accelerators used by the workload is dynamically adjusted while the workload is running.
Embodiment 7. The method as recited in any of embodiments 1-6, wherein the workload is able to issue the accelerator call without being aware of a type, or number, of accelerators that are available for the accelerator job.
Embodiment 8. The method as recited in any of embodiments 1-7, wherein an order of accelerators to be used for the accelerator job is configurable by a user.
Embodiment 9. The method as recited in any of embodiments 1-8, wherein the accelerator service instance and/or the locally available accelerator each comprise one of a QPU or a GPU.
Embodiment 10. The method as recited in any of embodiments 1-9, wherein the accelerator service instance is provisioned by a catalog.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

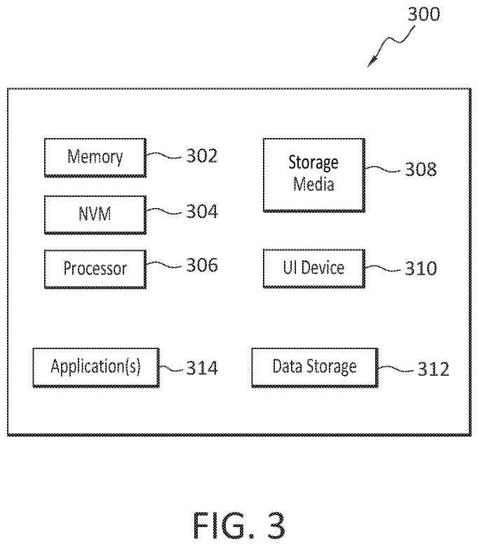

With reference briefly now to FIG. 3, any one or more of the entities disclosed, or implied, by FIGS. 1-2 and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI (user interface) device 310, and data storage 312. One or more of the memory components 302 of the physical computing device 300 may take the form of solid state device (SSD) storage. As well, one or more applications 314 may be provided that comprise instructions executable by one or more hardware processors 300 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying an accelerator service instance associated with a workload;
calling a service broker associated with the accelerator service instance to obtain information needed to use the accelerator service instance;
receiving an accelerator call, and accelerator job information concerning an accelerator job, from the workload;
in response to the accelerator call, spinning up a new process dedicated to the accelerator job;
as part of the new process, running the accelerator job using either the accelerator service instance, or a locally available accelerator; and
returning data, generated by running the accelerator job, to the workload.

2. The method as recited in claim 1, wherein the accelerator service instance is associated with a container of the workload.

3. The method as recited in claim 1, wherein the accelerator service instance is listed in a catalog of selectable accelerator services.

4. The method as recited in claim 1, wherein the accelerator call is received from a container of the workload by way of an application program interface.

5. The method as recited in claim 1, wherein the method is performed as part of an accelerator management job.

6. The method as recited in claim 1, wherein a number of accelerators used by the workload is dynamically adjusted while the workload is running.

7. The method as recited in claim 1, wherein the workload is able to issue the accelerator call without being aware of a type, or number, of accelerators that are available for the accelerator job.

8. The method as recited in claim 1, wherein an order of accelerators to be used for the accelerator job is configurable by a user.

9. The method as recited in claim 1, wherein the accelerator service instance and/or the locally available accelerator each comprise one of a QPU or a GPU.

10. The method as recited in claim 1, wherein the accelerator service instance is provisioned by a catalog.

11. A non-transitory storage medium having stored therein instructions that are executable by one or more hardware processors to perform operations comprising:
identifying an accelerator service instance associated with a workload;
calling a service broker associated with the accelerator service instance to obtain information needed to use the accelerator service instance;
receiving an accelerator call, and accelerator job information concerning an accelerator job, from the workload;
in response to the accelerator call, spinning up a new process dedicated to the accelerator job;
as part of the new process, running the accelerator job using either the accelerator service instance, or a locally available accelerator; and
returning data, generated by running the accelerator job, to the workload.

12. The non-transitory storage medium as recited in claim 11, wherein the accelerator service instance is associated with a container of the workload.

13. The non-transitory storage medium as recited in claim 11, wherein the accelerator service instance is listed in a catalog of selectable accelerator services.

14. The non-transitory storage medium as recited in claim 11, wherein the accelerator call is received from a container of the workload by way of an application program interface.

15. The non-transitory storage medium as recited in claim 11, wherein the operations are performed as part of an accelerator management job.

16. The non-transitory storage medium as recited in claim 11, wherein a number of accelerators used by the workload is dynamically adjusted while the workload is running.

17. The non-transitory storage medium as recited in claim 11, wherein the workload is able to issue the accelerator call without being aware of a type, or number, of accelerators that are available for the accelerator job.

18. The non-transitory storage medium as recited in claim 11, wherein an order of accelerators to be used for the accelerator job is configurable by a user.

19. The non-transitory storage medium as recited in claim 11, wherein the accelerator service instance and/or the locally available accelerator each comprise one of a QPU or a GPU.

20. The non-transitory storage medium as recited in claim 11, wherein the accelerator service instance is provisioned by a catalog.
